(19) United States
(12) Patent Application Publication
(10) Pub. No.: US 2006/0075685 A1
(43) Pub. Date: Apr. 13, 2006

(54) Displacement mechanism

(76) Inventor: John Gustafson, Fall Creek, WI (US)

Correspondence Address: Thomas N. Phung;Jacobson and Johnson, Suite 285, One West Water Street, St. Paul, MN, 55107-2080, US

(21) Appl. No.: 11/249,853

(22) Filed: Oct. 13, 2005

Related U.S. Application Data
(63) Continuation-in-part of application No. 11/055,417, filed on Feb. 10, 2005.
(60) Provisional application No. 60/618,524, filed on Oct. 13, 2004.

(51) Int. Cl. E05F 15/16

(52) U.S. Cl. 49/349

(57) ABSTRACT

A window displacement mechanism comprising a frame, a motor, at least one elongated curved member having a set of threads thereon, and at least one member having a set of threads rotatably mateable with the set of threads on the elongated curved member so that when the member and the elongated curved member are rotated relative to each other one can displace a window carrying extension.

### CROSS REFERENCE TO RELATED APPLICATIONS

This application is a continuation in part of my co-pending patent application Ser. No. 11/055,417; Feb. 10, 2005; titled DISPLACEMENT MECHANISM and also claims priority to currently pending U.S. Provisional Application Ser. No. 60/618,524; filed on Oct. 13, 2004; titled VEHICULAR WINDOW MECHANISM.

### FIELD OF THE INVENTION

This invention relates generally to displacement hardware and, more particularly, to displacement mechanisms suitable for raising and lowering a motor vehicle window from within a curved doorframe.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The mechanism for use in raising and lower automobile windows, particularly those in curved doors are generally complex and require multiple components to raise and lower the window. The present invention provides a displacement mechanism that uses a curved member with threads thereon that can rotatingly engage a further threaded member to provide for axial displacement of the further member with respect to the curved threaded member so an item such as window or the like can be raised or lowered within a non-linear housing such as a curved automobile door.

Briefly, the invention comprises a displacement mechanism that can raise and lower an article such as an automobile window where a window drive mechanism must follow a curved path.

In one embodiment the clearance between a drive nut and a curved shaft is such that the drive nut can rotatably follow the curved shaft without binding through the use of a large clearance between the threads of the drive nut and the threads on the curved support column.

In still another embodiment the drive nut is made sufficiently thin so as to inhibit binding by limiting thread contact as the drive nut follows the curved shaft.

In still another embodiment the drive nut is allowed to yaw or pivot about its axis of rotation as the nut rotates about the curved, threaded, support column to thereby enable the drive nut to displace the cross member carrying the window to enable the raising and lowering of a window even though the displacement mechanism is mounted within the confines of a curved housing. In a further embodiment a flexible threaded drive member rotates about a curved cylindrical rod to rotatingly engage a female thread in a housing to raise or lower a mechanism carrying a window or the like.

### BRIEF SUMMARY OF THE INVENTION

The present invention comprises a window displacement mechanism having a motor, an elongated curved shaft having a set of threads thereon and a member having a set of threads rotatably mateable with the set of threads on the elongated curved member so that when the member and the elongated curved member are rotated relative to each other one can displace a window carrying extension. The window displacement mechanism also includes a housing having a first end and a second end and a frame comprising a first side rail and a second side rails for supporting the first end and the second ends of the housing to permit rotation the member while preventing the rotation of the housing.

The present invention also comprises a window displacement mechanism having a motor, a curved rod and a rotatable elongated flexible drive member having a set of threads encompassing the curved rod. The window displacement mechanism further includes a housing having a set of threads thereon mateable with the set of threads of the flexible drive member so that the rotation of the drive member results in the displacement of a window carrying extension.

### DESCRIPTION OF THE PRIOR ART

U.S. Pat. No. 4,289,300 teaches a car jack comprising a column attached at its bottom to a base, and a load-carrying arm pivoted to the column and movable to a screw spindle.

U.S. Pat. No. 5,102,090 teaches a mounting bracket for mounting a window regulator motor housing with three holes to a door panel having three holes aligned with the holes in the power regulator motor and three slots.

### BRIEF DESCRIPTION OF THE DRAWINGS

FIG. 1 is a perspective view of a displacement mechanism having a curved support column;

FIG. 2 is a side view of the displacement mechanism of FIG. 1;

FIG. 3 is partial section view of a gear driven drive nut for following the curved and threaded support column of FIG. 1;

FIG. 4 is an end view of the drive gears for rotating the drive nut of FIG. 3;

FIG. 5 is a perspective view of the drive mechanism in conjunction with two threaded support columns;

FIG. 6 is an enlarged section view of the engagement between a threaded support column and a threaded driver;

FIG. 7 shows an alternate embodiment wherein the thread support column has an elongated cross section area to compensate for the curved support column; and

FIG. 8 shows a perspective view of the displacement hardware;

FIG. 8a shows a support bracket for flowing along a slot in the displacement hardware of FIG. 8;

FIG. 8B shows an exploded view of a drive mechanism;

FIG. 9 shows an alternate embodiment of a drive mechanism;

FIG. 10 shows a partial sectional view of a flexible spiral drive member for arising and lowering a window;

FIG. 11 shows a partial perspective view of a displacement mechanism having a pair of rotor driven nuts located proximal the ends a housing;

FIG. 12 show a partial perspective view of a displacement mechanism having a rotor driven nut located within a housing midway between the ends of the housing;

FIG. 13 shows a perspective view of a displacement mechanism having an electric motor positioned proximal a right angle to a pair of curved threaded rod;

FIG. 14 shows a perspective view of an alternative embodiment of a displacement mechanism of the present invention,.

FIG. 15 shows a partial cross-sectional view of the displacement mechanism of FIG. 14;

FIG. 16 shows a top view of the displacement mechanism of FIG. 14;

FIG. 17 shows a cross-sectional view of an alternative embodiment of a flexible drive member comprising of an L-shaped coil; and

FIG. 18 shows a partial perspective view of an alternative embodiment of a displacement mechanism having a flat motor.

### DESCRIPTION OF THE PREFERRED EMBODIMENT

FIG. 1 shows a perspective view of a curved displacement mechanism 10 for moving an item such as a motor vehicle window upward or downward. The displacement mechanism 10 includes a cross member 12 that has its ends slidingly confined within a curved side rail 11 and a curved side rail 13. The mechanism 10 includes a rectangular shaped frame 18 having a curved slot 11a on rail 11 and an identical curved slot on the other rail 13 (not shown) for the cross member 12 to slide therein. The displacement mechanism 10 is designed to fit within the curved housing of a motor vehicle door.

Located centrally within mechanism 10 is a curved threaded support column 14 that is the support column 14 has a finite radius of curvature as opposed to a straight column that has an infinite radius of curvature. The column ends 14a and 14b are fixedly supported within frame 11. Located on the cross member is a drive nut 15 which is rotatable about curved male threads 14c on shaft 14 while maintainable within a housing 16. Drive nut 15 contains a well known conventional straight axis female threads that extend along a central axis of the drive nut. Conventional straight axis female nuts are normally used on straight shaft bolts or the like to fasten articles together. A central axis of the straight female threads, in essence, has an infinite radius of curvature while the support column 34 in contrast has a finite radius of curvature. However, as one knows attempting to rotate a conventional nut with a straight axis female thread on a bent or curved shaft produces binding between the threads. If the threads bind it inhibits one from rotationally engaging a conventional straight female thread on a curved threaded male member.

The present invention minimizes or eliminates the thread-binding problem to allow a conventional straight female thread to rotatingly engage a curved male thread on an elongated column. By being able to provide rotational engagement between a conventional female thread and a curved threaded male member it allows the combination to be operably incorporated into a curved displacement mechanism so that one can raise and lower items such as vehicle windows that are located in curved door frames where the displacement mechanism needs to be curved to fit within the curved door housing.

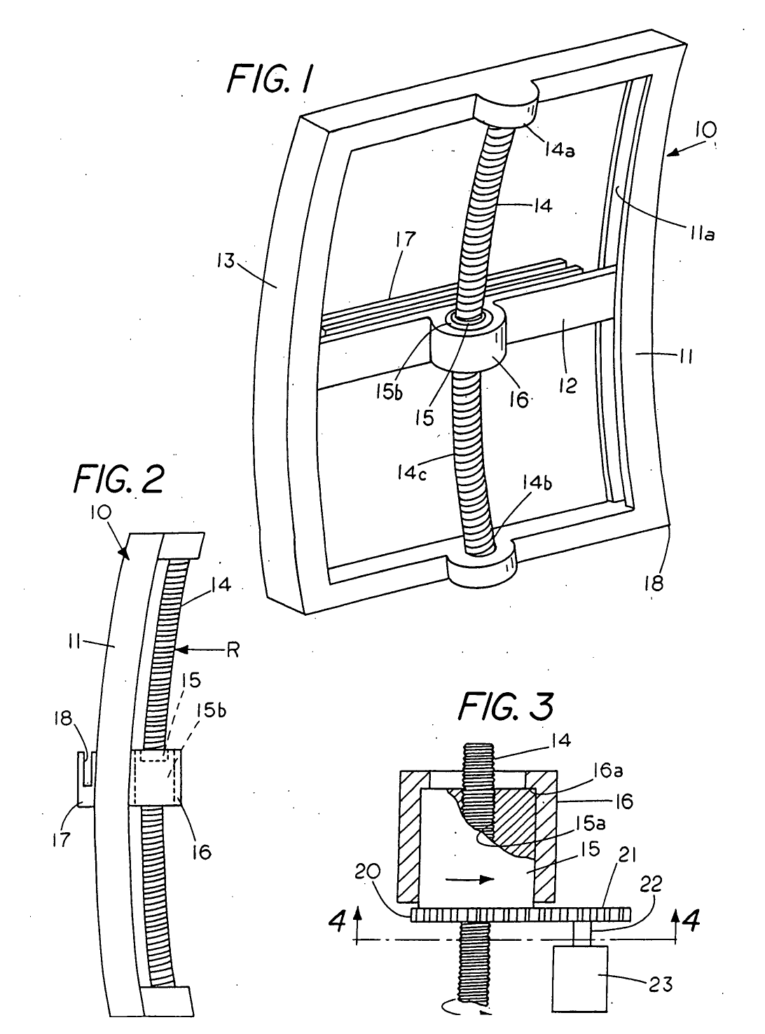

Referring to FIG. 2 the finite radius of curvature or member 14 is identified by R. Extending around curved member 14 is housing 15 having an extension or arm 17 with a slot 18 located in extension 17 to allow one to therein support an item such as a window found in a typical automobile. That is, automobiles have side windows that can be raised or lowered to allow one to open and close the window. In most cases the door is curved which requires one to use a lifting mechanism that can raise and lower a window yet remain within the curved housing between the interior and exterior of the door. The displacement mechanism 10 of the present invention maintains the rotatable nut 15 within the housing 16 on slidable cross member 12 as the extension 17 is raised or lowered.

Referring to FIG. 3 there is shown a partial cross sectional view of a rotatable drive nut 15 that is axially restrained within hub 16 by annular ledge 16a. The curved and threaded support column 14 extends through the rotatable nut 15, which has a conventional straight axis female thread 15a therein. Located below drive nut 15 and secured thereto is a spur gear 20 that is held in axial position along curved member 14 so as to mesh with a further spur gear 21 that is rotatable driven by a shaft 22 which is connected to electric motor 23. In operation the rotation of shaft 22 rotates gear 21 which in turn rotates gear 20 that causes rotation of drive nut 15 about curved threaded column 14 which cause the housing 16 to be displaced along curved threaded rod 14. That is rotation in one direction cause housing 16 to move upward and rotation in the opposite direction causes housing 16 to be lowered. As a result a window carried by member 17 can be raised or lowered.

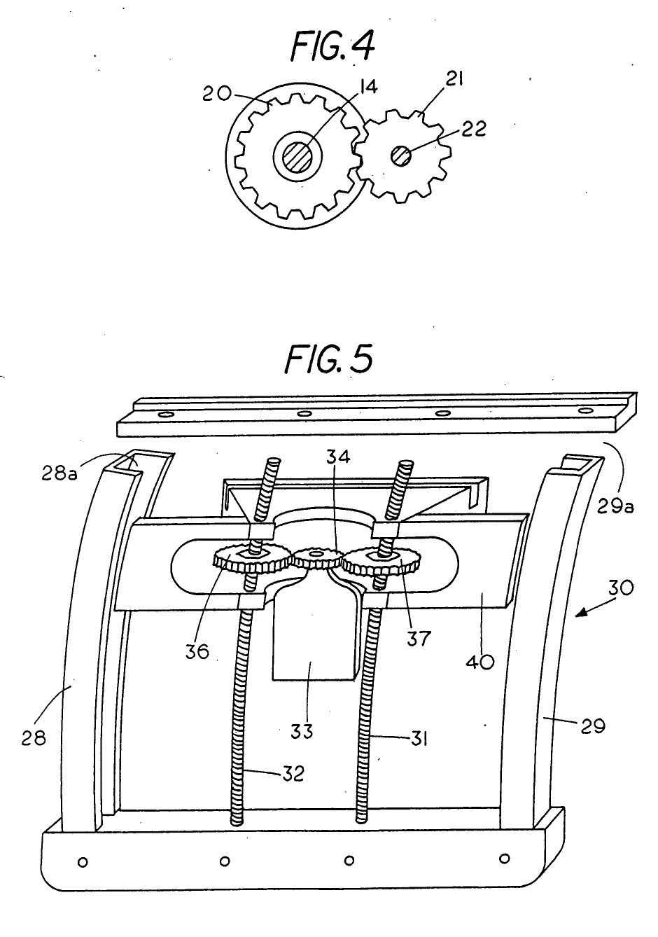

FIG. 4 shows a sectional view taken along lines 4-4 showing the meshing or engaging relationship of gear 20 and 21 so that rotation of shaft 22 cause rotation of gear 20 about curved threaded column 14.

FIG. 5 shows an alternate embodiment wherein the elevation mechanism 30 is included with two curved support column or curved threaded shafts 31 and 32 with a drive motor 33 having a gear 34 for engaging with a drive nut 36 located around curved shaft 32 and a drive nut 37 located around curved shaft 31. The drive nuts 36 and 37 are rotationally driven by the gear 34 and are confined within housing 40 similarly to the confinement of nut 15 as shown in FIG. 3. A drive motor 33 rotates gear 34, which in turn rotates drive nuts 36 and 37. In order to provide for elevation or lowering of the sliding housing 40 one of the shafts can be provided with a right hand thread and the other can be provided with a left hand thread. An alternate embodiment could use the same threads but use a further gear so that rotation of the drive gear 34 causes the same axial displacement of each of the drive nuts 36 and 37. The displacement of the housing 40 is identical to the displacement of member 17 in FIG. 1 except that two drive nuts are used instead of one. That is the member 40 slides in curved slot 28a in member 28 and in curved slot 29a in curved member 29 to provide for raising and lowering a window or the like carried by housing 40.

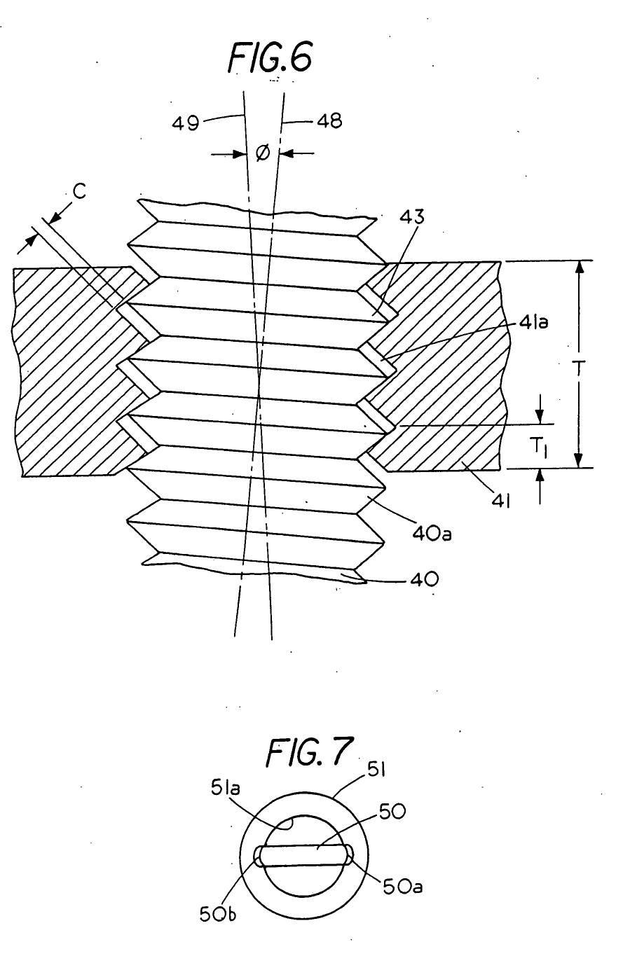

In order to appreciate how the curved threaded member 14 can follow a straight thread on a drive nut reference should be made to FIG. 6 which shows an enlarged view of a portion of a rotatable drive nut 41 and a curved threaded support column 43. Reference numeral 48 identifies a central axis of a portion of the male threads 40 within the rotatable nut and reference numeral 49 identifies a central axis of the female threads in the rotatable nut 41. Note, the misalignment of the axis 48 and 49 which is caused by the curved support column 43 not being in axial alignment with the axis 49 of the female threads. The embodiment of FIG. 6 has been provided with oversize female threads. That is, the amount of clearance “c” between the drive nut threads 41a and the support threads 40a has been increased sufficiently so that the drive nut can be slightly tipped along its rotational axis and rotated therearound without binding against the threaded support column. A FIG. 6 show the axis of the male thread makes with respect to the female threads makes an angle ø. The angle ø is characterized is being greater than would occur between a shaft with a standard size male thread and a nut with a standard size female threads. The clearance “c”, which is greater than the clearance between the threads on a conventional female thread and male thread allows the drive nut to tip to compensate for the curved threads of the support column, yet the clearance is sufficient small so that when the drive nut in a tipped condition the drive nut still maintains threaded engagement with the threaded column so that the drive nut 41 can be rotationally driven along the curved thread column 40. Thus the present invention includes over-sizing a female thread with respect to a male thread so as to increase the clearance between the threads while maintaining sufficient thread engagement to provide rotational engagement between the threads.

FIG. 7 shows a partial view of an alternate embodiment wherein a curved drive shaft 50 with an elongated cross section is provided with teeth 50a on one side and teeth 50b on the opposite sides. The drive nut 51, which contains a continuous female thread 51a, is allowed to follow along the partial threaded curved column 50 but additional clearance occurs in this arrangement between the curved column 50 and the drive nut 51 since only a portion of the threads on the drive nut 51 and the curved column 50 are in engagement with each other. Thus, with embodiment of FIG. 7 only a portion of the teeth on the drive nut 51 are used engage the opposite threaded edges of the curved column 50 which allows the drive nut 51 to rotate with respect to the threaded column 50 even though the curved column does not have a central axis of the curved column within the drive nut in alignment with a central axis of the rotatable nut.

In an alternate embodiment to accommodate the coactions between a curved threaded member and a drive nut with straight through conventional threads I provide a nut and a curved threaded support column wherein the drive nut may contain only a single continuous thread on the drive nut which can be maintained in engagement with the curved support column thus allowing the drive nut to follow a more severely curved column without binding. That is, only one circumferential section of male thread is in engagement with one circumferential section of female thread as opposed to the drive nut of FIG. 6, which shows four circumferential sections of female threads 41a in engagement with the four threads 40a on the curved shaft 40. By reducing the thickness T of the drive nut 41 to the thickness T₁ only one circumferential section of the female thread 41a will be in engagement with the tread 40a on the curved column 40. Thus allowing the nut to follow a curved member with a smaller radius of curvature.

In still another embodiment I can stack the thin drive nuts while loosely coupling them to each other. This allows the thin drive nuts to become rotationally misaligned as the drive nuts are rotated thus allowing the stacked drive nuts to follow a curved shaft.

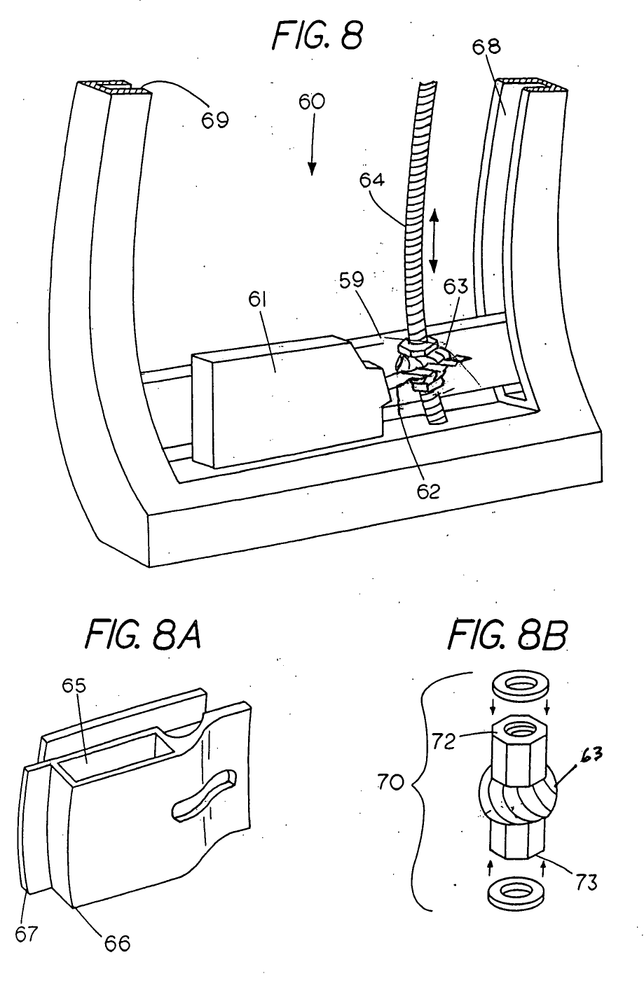

FIG. 8 is a partial perspective view of a displacement mechanism 60 with an electric motor 61 positioned at a right angle to the threaded rod 64. A worm gear 62 is attached to the shaft of the electric motor. The worm gear turns a gear 63 having circumferential teeth and a center opening having threads that forms threaded engagement with curved rod 64 in the embodiment of FIG. 8 rotation of worm gear 62 provides for rotation of gear 63 and consequently displacement along rod 62. Cross member 59 is similar to cross member 12 carries motor 61 as well as a window to allow for motor 61 to move the cross member 59 along the curved slots 68 and 69 in the manner described with respect to the embodiment of FIG. 1.

FIG. 8A shows a motor and gear bracket 66 for engaging a window with the bracket including a motor compartment 65. The bracket includes an elongated guide 67 to permit the unit to follow a guide rail such as guide rail 69 in frame 60. Bracket 66 is mounted on one side of housing and preferably mounted to a cross member 59 that has a similar elongated guide that engages curved slot 68.

FIG. 8B shows an alternate drive mechanism 70 comprising a central worm gear member 63 with a top threaded nut 72 and a lower threaded nut 73 which are secured to each end of worm gear 63. The arrangement of FIG. 8B allows top nut 72 to rotate with respect to nut 73 to provide further compensation. That is to minimize binding between the drive nuts and the curved rod the drive nuts can be spaced from each other by the worm gear 63. Since the curved shaft would limit how far the drive nuts can be spaced from each other the use of the worm gear allows the two drive nuts to be driven while maintaining the drive nuts in a spaced condition from each other which can inhibit or minimize binding between the drive nuts and the curved shaft.

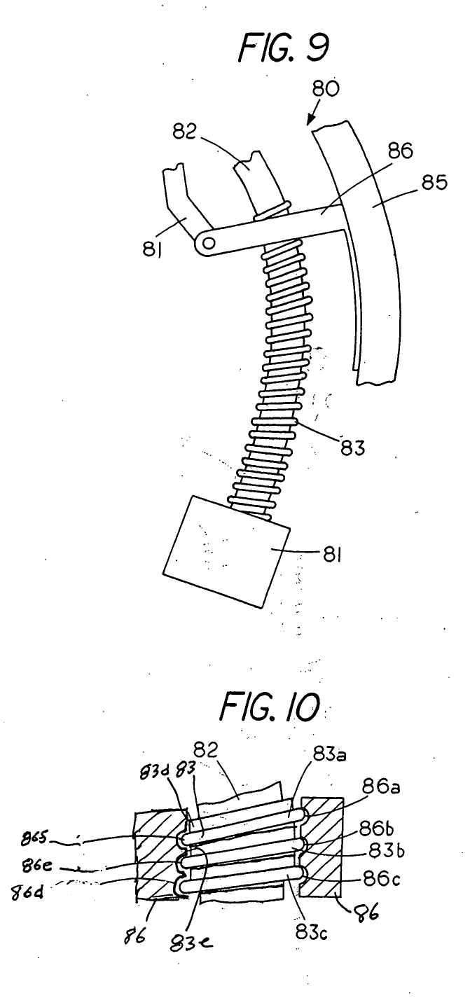

FIG. 9 shows a partial front view of another embodiment of my invention. The window drive mechanism 80 includes a motor 81, a curved non-threaded shaft 82 and a flexible drive member 83, which is rotationally driven by motor 81. The flexible drive member 83 is spring like with the individual coils able to separate from each other as the flexible drive shaft is rotated about curved shaft 82. A housing 85 provides support for arm 86 that includes a female thread therein with arm 86 following along housing 85 as the flexible drive member 83 is rotated. The article, such as a window, which is to be raised or lowered, is attached via member 81 to arm 85. Thus rotation of member 43 causes the arm 86 to move up or down along curved rod 82.

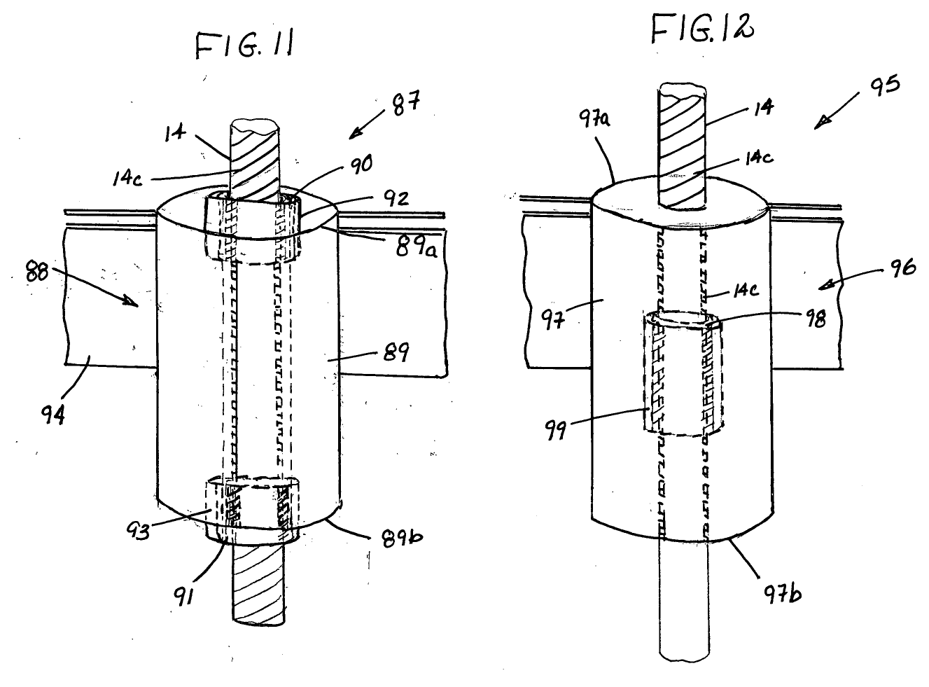

FIG. 10 shows a partial sectional view of the curved support rod 82 and three flexible coils drive members 83a, 83b and 83c, which follow along curved support rod 82. That is the curved support member extends through the lumen in the flexible coil member 83. The male threads 86a, 86b and 86c on the right side of the coil 83 are shown located in engagement with the female threads in one side of arm 86 and the male threads 86a, 86b, and 86c, which have a smaller spacing therebetween due to the curvature of the spring are shown located in contact with female threads 86d, 86e and 86f. This arrangement of different thread spacing on each side allows one to compensate for the curvature of the spring when the female threads are located on the opposite sides of the curve of the rod. If the female threads were located on the sections perpendicular to the plane of the drawing the female threads would be provided with the same spacing. A feature of the flexible drive member 83 is that it provides an integral circumferential spacer between each coil of the drive member to thereby cause the outer circumferential edge of each of the coils to project radially outward sufficiently to laterally engage the threaded recess in arm 86. For example, on top of coil 83a is a spacer 83d and on top of coil 83b is a spacer 83e. As can be seen in FIG. 10 the spacer 83e maintains each of the coils 83b and 83c in a spaced condition from each other. Likewise the other coils are similarly held in a spaced condition and will not be described herein. While the coils in FIG. 10 are shown as being round the coils and integral spacers could have an L-shape. In operation of the embodiment of FIG. 9 the rotation of member 83 about the curved shaft 82 cause the coils 83a, 83b and 83c to act as threads to move the housing 86. Thus in the embodiment of FIG. 9 instead of rotationally driven a nut about a hollow threaded shaft a flexible threaded shaft 83 is rotationally driven about a curved member 82 to produce the necessary displacement.

In the embodiment shown in FIG. 10 the housing is comprised of two sections that are on opposite sides of the thread member 83. However, if desired the female threads could be part of an encircling member rather than making a partial engagement with the spiral thread as illustrated in FIG. 10.

FIG. 11 is a partial perspective view of a displacement mechanism 87, which although not shown comprises similar components to the displacement mechanism 10 of FIGS. 1, 2, and 3. However, unlike displacement mechanism 10, displacement mechanism 87 includes an electric motor 88 located in a housing 89. As shown in the embodiment of FIG. 11, motor 88 includes a first drive nut 90 located proximal a first end 89a of housing 89 and a second drive nut 91 located proximal a second end 89b of housing 89 with drive nuts 90 and 91 each shown matingly engaging the curved threads 14c of curved shaft 14. Motor 88 also includes a first rotor 92 and a second rotor 93 for driving first drive nut 90 and second drive nut 91 about the curved threads 14c of curved shaft 14 which leads to the displacement of housing 89 along curved shaft 14 thereby enabling the raising and lowering of a window carried by an extension 94.

FIG. 12 is a partial perspective view of a displacement mechanism 95 similar to the displacement mechanism 87 of FIG. 11. However, unlike displacement mechanism 87 which includes rotor driven nuts 90 and 91 located proximal the ends of housing 89, displacement mechanism 95 comprises a motor 96 located within a housing 97 with motor 96 having a single drive nut 98 located proximally midway between a first end 97a and a second end 97b of housing 97 and matingly engaging the curved threads 14c of curved shaft 14. Similar to nuts 90 and 91 of displacement mechanism 87, the nut 98 of displacement mechanism 95 is also driven about the curved threads 14c of curved shaft 14 by a rotor 99.

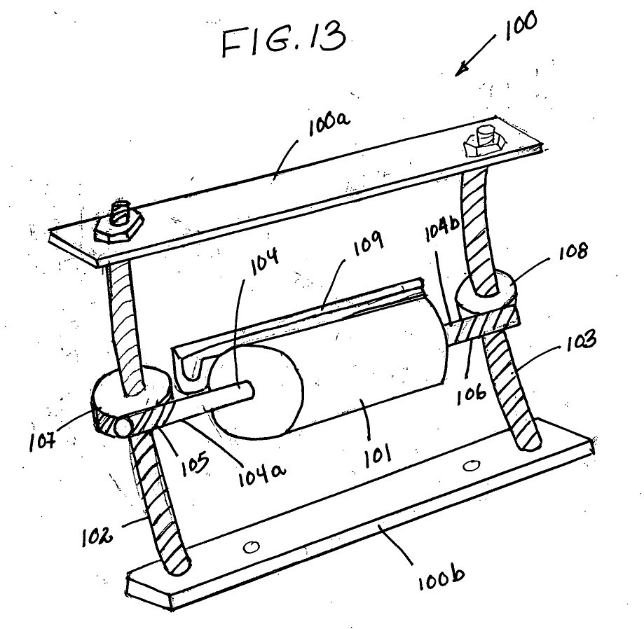

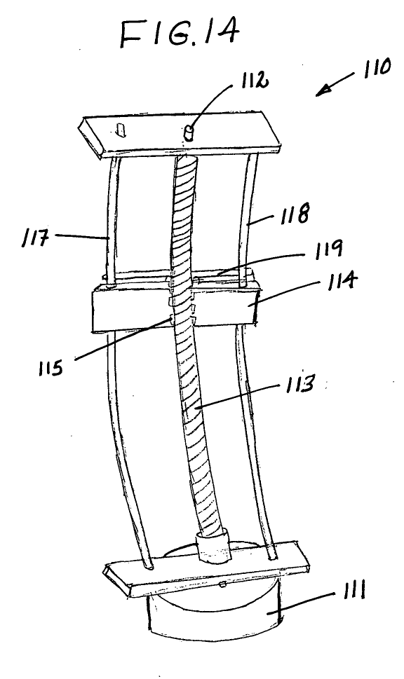

FIG. 13 shows a perspective view of a displacement mechanism 100 having an electric motor 101 positioned proximal a right angle to a pair of curved threaded rod 102 and 103 with the curved threaded rod 102 and 103 supported at proximal each of their ends by mounting brackets 100a and 100b. The motor 101 includes a shaft 104 having a first end 104a and a second end 104b extending therethrough. A first worm gear 105 is attached to the first end 104a of the shaft 104 and a second worm 106 is attached to the second end 104b of the shaft 104.

Displacement mechanism 100 also includes a first gear 107 having circumferential teeth that matingly engages the teeth of first worm gear 105 and a center opening having threads that forms threaded engagement with curved threaded rod 102 and a second gear 108 having circumferential teeth that matingly engages the teeth of second worm gear 106 and a center opening having threads that forms threaded engagement with curved threaded rod 103.

Similar to the displacement mechanism 60 of FIG. 8, first worm gear 105 and second worm gear 106 function by rotating to turn first gear 107 and second gear 108, the turning of gears 107 and 108 resulting in the displacement of gears 107 and 108 and motor 101 along threaded rods 102 and 103. Since an extension 109 is attached to motor 101, the displacement of motor 101 enables the raising and lowering of a window carried by an extension 109

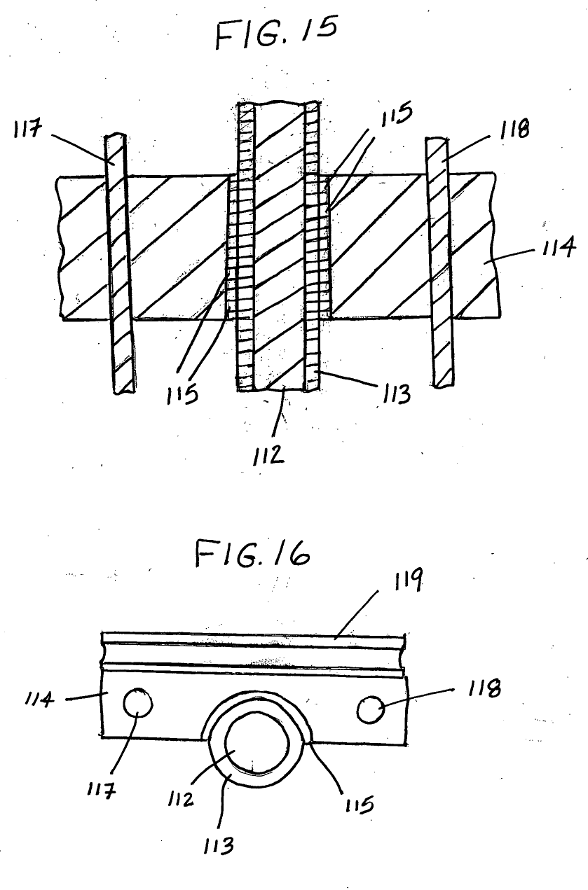

Referring to FIGS. 14, 15, and 16, FIG. 14 shows a perspective view of an alternative embodiment of a displacement mechanism 10. FIG. 15 shows a partial cross-sectional view and FIG. 16 shows a top view of displacement mechanism 110. Displacement mechanism 110 is similar to the window mechanism 80 of FIG. 8 in that displacement mechanism 110 includes a motor 111, a curved shaft 112 and a flexible drive member 113, which is rotationally driven about curved shaft 112 by motor 111.

In the embodiment of FIG. 14, flexible drive member 113 comprises a spring-like shape with the individual coils of flexible drive member 113 positioned in a spaced condition from each other thereby enabling the coils of flexible drive member 113 to function as threads that run along curved shaft 112.

Displacement mechanism 110 also includes a housing 114 having a set of threads 115 thereon, the threads 115 of the guide member 114 matingly engageable with the threads formed by the coils of flexible drive member 113. Displacement mechanism 110 further includes a pair of guide rails 117 and 118 to provide stability to housing 114 while also maintaining the mating engagement of the housing 114 with flexible drive member 113.

In the operation of the about embodiment, an article, such as a window, to be displaced is attached to housing 114 via an extension 119 after which a rotation of flexible drive member 113 by the motor 111 results in the displacement of the extension 119 and in turn the displacement of the window along curved shaft 112.

It is noted that the displacement mechanism 110 of FIG. 14 is advantageous in that motor 111 remains stationary or in a fixed position throughout the displacement of the window along curved shaft 112 thereby preventing potential problems associated with the movement of the motor, i.e. stretching, bending, and possible breakage of the electrical wires that powers the motor.

In regards to the general shape of the flexible drive member, it is noted that while providing a spring-like shape flexible drive member as shown in the embodiment of the flexible drive member 113 of FIG. 14 works for its intended purpose, that is enabling the coils of flexible drive member 113 to act as threads for mating with the threads 115 of housing 114, on of the disadvantages of the aforementioned is the potential spring action, and more specifically, the potential compression of the flexible drive member which can lead to the window to be displaced downward, potentially allowing someone eventual access to the inside of the vehicle. In addition, compression of the flexible drive member can also lead to the elimination of threads for mating with the threads 115 of housing 114, thereby hindering the movement of the housing along the curved shaft.

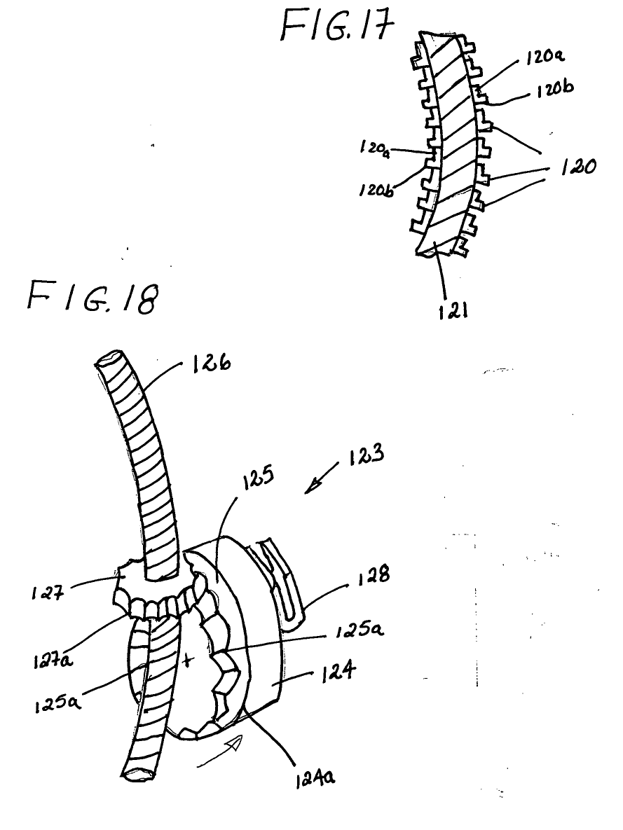

To solve the above, FIG. 17 shows a cross-sectional view of an alternative embodiment of a flexible drive member comprising of an L-shaped coil 120, the L-shaped coil 120 shown encompassing a curved shaft 121. In regards to the L-shaped coil, the L-shaped coil 120 comprises a body 120a having a member 120b protruding therefrom with member 120b acting as threads for mating with the threads 115 of housing 114 of FIG. 14. Although member can protrude from the body 120a of the L-shaped coil at different angle, member 120b is shown in FIG. 17 as protruding perpendicular from body 120a of L-shaped coil 120. An advantage of a flexible drive member comprising of the L-shaped coil 120 is that L-shaped coil 120 limits the downward displacement of the window compressed while providing for threads for mating with the threads 115 of housing 114 while in the compressed condition.

FIG. 18 shows a partial perspective view of an alternative embodiment of a displacement mechanism 122 of the present. Displacement mechanism 122 comprises a housing 123 having a flat electric motor 124 with a motor gear 125 located on a face 124a of the motor 124. It is noted that the above-mentioned flat motor hardware is commercially available from a number of sources including Danaher Motion GPS of Radford, Va. and Panasonic Corporation of North America of Secaucus, N.J.

Displacement mechanism 122 also includes a curved threaded shaft 126 and a spur gear 127 having circumferential teeth 127a that matingly engages the teeth 125a of motor gear 125 and a center opening having threads that forms threaded engagement with curved threaded shaft 126.

In operation, motor 124 powers motor gear 125 to rotate to turn spur gear 127, the turning of spur gear 127 results in the displacement of spur gear 127 along with housing 123 along curved threaded shaft 126. Since housing 123 includes an extension 128 attached thereto, the displacement of housing 123 enables the raising and lowering of a window carried by the extension 128.

Thus with the embodiments of the present invention one can displace a window or the like for a motor vehicle such as an automobile by using a curved threaded member. In one embodiment the curved column is maintained fixed while a drive nut is rotated about the curved threaded member and in the other embodiment the nut remains stationary while the flexible threaded member is rotated. In both instances one can axially displace an item even though a curved threaded shaft is used. Thus the present invention provides axially displacement even though the thread axis of the members is not in axial alignment with each other.

Thus the present invention can include but not limited to a threaded rotatable drive nut or a threaded rotatable curved drive shaft. The use of round or oversized threads on the threaded nut can prevent binding in addition one can use a self-lubricated nut or both. To complete the window mechanism a brush type electric motor or a brushless electric motor with a controller board with the controller board incorporating any of the following soft start, resistance sensing, automatic reverse sensor with warning device or auto tint for anti-glare or security.

I claim:

1. A window displacement mechanism comprising:
a frame;
a motor;
at least one elongated curved member having a set of threads thereon;
at least one member having a set of threads rotatably mateable with the set of threads on the elongated curved member so that when the member and the elongated curved member are rotated relative to each other one can displace a window carrying extension.

2. The window displacement mechanism of claim 1 wherein the motor powers the rotation of the at least one member.

3. The window displacement mechanism of claim 2 wherein the at least one member having a set of threads comprises a drive nut located within a housing of the motor midway between the ends of the motor housing.

4. The window displacement mechanism of claim 2 wherein the at least one member having a set of threads comprises a first drive nut and a second drive nut located within a housing of the motor with the first drive nut positioned proximal a first end of the motor housing and the second drive nut positioned proximal a second end of the motor housing.

5. The window displacement mechanism of claim 2 including a cross member having a first end for sliding engagement with a first side rail of the frame and a second end for sliding engagement with s second side rail of the frame.

6. The window displacement mechanism of claim 1 wherein the at least one member comprises a gear having a center opening with threads rotatably mateable with the set of threads on the elongated curved member and a set of circumferential teeth rotatably mateable with the teeth of a motor powered gear.

7. The window displacement mechanism of claim 6 wherein the motor powered gear comprises a worm gear.

8. The window displacement mechanism of claim 6 wherein the motor powered gear comprises a spur gear.

9. The window displacement mechanism of claim 6 wherein the at least one elongated curved member comprises a first elongated curved member having a set of threads and a second elongated curved member having a set of threads and wherein the at least one member comprises a first gear having a center opening with threads rotatably mateable with the set of threads on the first elongated curved member and a set of circumferential teeth rotatably mateable with the teeth of a first motor powered gear and a second gear having a center opening with threads rotatably mateable with the set of threads on the second elongated curved member and a set of circumferential teeth rotatably mateable with the teeth of a second motor powered gear.

10. The window displacement mechanism of claim 9 wherein the first motor powered gear and the second motor powered gear comprises a first worm gear extending from a first end of the motor and a second worm gear extending from a second end of the motor.

11. The window displacement mechanism of claim 1 wherein the elongated curved member comprises a coil rotatably encompassing a curved fixed rod.

12. The window displacement mechanism of claim 1 wherein the set of threads of the elongated member and the set of threads on the curved member have sufficient clearance therebetween to accommodate a curvature of the rod without binding thereon.

13. A window displacement mechanism comprising:
a motor;
a curved rod;
a rotatable elongated flexible drive member having a set of threads thereon, the elongated flexible drive member encompassing the curved rod;
a housing having a set of threads thereon, the threads of the housing mateable with the set of threads of the flexible drive member so that the rotation of the drive member results in the displacement of a window carrying extension.

14. The window displacement mechanism of claim 13 wherein the set of threads of the elongated flexible member and the set of threads on the housing have sufficient clearance therebetween to accommodate a curvature of the rod without binding thereon.

15. The window displacement mechanism of claim 13 wherein the elongated flexible member comprises a coil rotatably encompassing a curved fixed rod.

16. The window displacement mechanism of claim 13 wherein the motor is stationary throughout the displacement of the window carrying extension.

17. The window displacement mechanism of claim 13 including a pair of guide rails for supporting the housing while maintaining the mating the threads of the housing with the set of threads of the flexible drive member.

18. The window displacement mechanism of claim 15 wherein the coil comprises L-shaped coils rotatably encompassing a curved fixed rod.

19. An elevation mechanism comprising:
a motor;
an elongated curved shaft having a set of threads thereon;
a member having a set of threads rotatably mateable with the set of threads on the elongated curved member so that when the member and the elongated curved member are rotated relative to each other one can displace a window carrying extension;
a housing having a first end and a second end;
a frame comprising a first side rail and a second side rails for supporting the first end and the second ends of the housing to permit rotation the member while preventing the rotation of the housing.

20. The window displacement mechanism of claim 19 wherein the set of threads of the elongated curved shaft and the set of threads on the member have sufficient clearance therebetween to accommodate the curvature of the elongated curved shaft without binding thereon.
